(19) United States
(12) Patent Application Publication
(10) Pub. No.: US 2005/0276035 A1
(43) Pub. Date: Dec. 15, 2005

(54) Fluid illumination devices

(76) Inventor: Joseph Edward Currie, Webster, NH (US)

Correspondence Address: JOSEPH E. CURRIE, 506 WHITE PLAINS RD., WEBSTER, NH, 03303-7112, US

(21) Appl. No.: 10/864,735

(22) Filed: Jun. 10, 2004

(51) Int. Cl. F21V 33/00

(52) U.S. Cl. 362/96

(57) ABSTRACT

A fluid flow illumination device provides for the automatic illumination of a flow of fluid flowing or emanating from a faucet or tap. The device is automatically actuated by fluid flow, and in one embodiment includes apparatus for automatically changing the color of the illumination according to the temperature of the fluid flow. This automatic temperature indication is of particular value to households in which small children may have access to kitchen or bathroom appliances where hot water may be dispensed. Another embodiment provides for temporarily installable and removable illumination, for use with beverage dispensers. As the temperature of fluids dispensed from such devices is generally uniformly cool or cold, the color of the illumination may be manually selected according to the user as desired. Only safe, very low voltage DC electrical powered is required to operate the solid-state illumination sources in all embodiments of the present invention.

### CROSS REFERENCE TO RELATED APPLICATIONS

(Not Applicable)

### STATEMENT REGARDING FEDERALLY SPONSORED RESEARCH OR DEVELOPMENT

(Not Applicable)

### BACKGROUND OF THE INVENTION

Scalding hot water from a faucet often warns the user by emanating visible water vapor, however water of 160 degrees Fahrenheit, possible in today's water heating systems, still account for many serious burns. The appearance of water flowing from a tap or faucet does nothing to alert the user as to the temperature of the water. While there may be some vapor emanating from hot tap water, this is not always the case, and it can be difficult to determine the temperature of the flowing water without touching the flow or the tap. Moreover, it often takes some time (perhaps a minute or so) for hot water to arrive at the faucet or tap outlet, once the hot water faucet has been turned on. A person actuating such a faucet has no way of knowing just when the hot water actually begins to flow from the tap or faucet, especially if the hot water supply is some distance away.

The need arises for a device that automatically provides an indication of temperature for water or other fluid flowing from a tap or other outlet. Rather than operating a dial or other indicator, that may be difficult for a child to understand, the device must provide an unambiguous color indication of the fluid temperature. Moreover, the device must illuminate the fluid itself, rather than being a remote indicator that may not be noticed. The device must be completely automatic in operation, requiring no manual actuation of switches or other action on the part of the user, other than turning on the water flow in the normal manner.

The device may also be adapted for decorative and/or advertising purposes so that rather than indicating a temperature by means of colored illumination of the fluid, specific colors may be provided for occasions as desired) e.g., green for St. Patrick's Day celebrations, etc.).

U.S. Pat. No. 3,450,159 issued to Ira E. Wilkin on Jun. 17, 1969 discloses a Control Box Water Faucets in which push button controls are used to momentarily or continuously actuate solenoids controlling the flow of cold or hot water in a faucet. The device also includes two indicator lights, one for hot and one for cold water flows. However, the lights provide only an indication that the appropriate solenoid is actuated, and do nothing to provide an actual indication of the temperature of the water flow emanating from the faucet. Moreover, the lights are in the same location as the control buttons, somewhat removed from the output and of the faucet.

U.S. Pat. No. 3,960,016 issued to Paul C. Symmons on Jun. 1, 1976 discloses a Water Mixing Valve With Temperature Indicator. The device comprises a standard mixing valve, as used in bathroom shower water supplies and the like, including a bimetallic temperature indicator. No color coding or liquid illumination means is disclosed.

U.S. Pat. No. 4,749,126 issued to H. P. M. Kessener, ET. Al. on Jun. 7, 1988 discloses an illuminated stream or flow of water with illumination operated by a flow switch 60 that is clearly intrusive with respect to the conduit. Kessener fails to show a non-intrusive flow detection means activated by the flow control handle, nor does Kessener disclose a sound microphone for detecting the sound of fluid flowing through the conduit. Kessener clearly does not show all of the claimed features of the present invention.

U.S. Pat. No. 4,978,833 issued to John T. Knepler on Dec. 18, 1990 discloses a Hot Water Dispenser Having Improved Water Temperature Control System. The only illumination means disclosed is in the form of an LED type “ready” light, as is well known in such devices as electric coffee urns and the like.

U.S. Pat. No. 5,019,690 issued to John T. Knepler on May 28, 1991 discloses a Boiling Water Dispenser Having Improved Water Temperature Control System. The illuminated indicator means is essentially identical to that of the same inventor's U.S. Pat. No. 4,978,833 discussed above.

U.S. Pat. No. 5,095,941 issued to John J. Betz on Mar. 17, 1992 discloses a Method And Apparatus For Actuating A Faucet. Hot and cold indicator lights are disclosed, but these two lights are nothing more than indicators of the position of an electrical switch that is used to select the water temperature desired. Thus, they do not actually indicate water temperature, but rather the position of the selector switch.

U.S. Pat. No. 5,125,433 issued to Charles F. DeMoss at al. on Jun. 30, 1992 discloses a System For Electronically Controlling The Temperature OF Water Delivered To A Bath, Shower Or The Like. No lighted temperature indicator means is disclosed.

U.S. Pat. No. 5,491,617 issued to Joseph E. Currie on Feb. 13, 1996 discloses an illumination device that illuminates a tap handle and an area proximate to a tap outlet. Said device communicates remote lamp illumination to said tap handle and to the tap outlet by separate fiber optic cables. No direct illumination from within the fluid flow or changing of illumination color depending on fluid flow temperature or microphone actuated switching is disclosed.

None of the above noted patents describes a microphone, or other sensitive diaphragm, to sense a fluid flowing through a conduit. None of the above noted patents, taken either singly or in combination, are seen to disclose the specific arrangement of concepts or claimed features disclosed by the present invention.

### SUMMARY OF THE INVENTION

By the present invention, improved fluid devices are disclosed.

Accordingly, one of the objects of the present invention is to provide an improved fluid illumination device that automatically illuminates the flow of fluid emanating from a faucet, tap, or other fluid outlet from within the flow.

Another of the objects of the present invention is to provide an improved fluid illumination device that operates automatically upon actuation of opening of one or more fluid control faucet or valve handles.

Yet another of the objects of the present invention is to provide and improved fluid illumination device that provides an automatic indication of the temperature of the fluid flowing from a faucet or tap outlet.

Still another of the objects of the present invention is to provide an improved fluid illumination device that requires no electrical connection to elements or structures within a fluid conduit or pipe.

A further objective of the present invention is to provide an improved fluid illumination device that, in an alternative embodiment, may be made completely portable and that is disposed completely outside of any fluid conduit or pipe.

An additional object of the present invention is to provide an improved fluid illumination device that, in one embodiment, provides for the manual selection of color(s) of illumination rather than automatically providing color indication dependent upon the fluid temperature.

A final object of the present invention is to provide an improved fluid illumination device for the purposes described that is inexpensive, dependable and fully effective in accomplishing its intended purposes.

With these and other objects in view that will more readily appear as the nature of the invention is better understood, the invention consists in the novel combination and arrangement of parts hereinafter more fully describes, illustrated and claimed with references being made to the attached drawings.

### BRIEF DESCRIPTION OF THE DRAWINGS

FIG. 1 is a perspective view of the present invention, as it would be installed at a kitchen or other sink or water faucet assembly, showing the arrangement of the major components.

FIG. 2 is a schematic block diagram showing the arrangement of the electrical components of the invention.

FIG. 3A is a side view in section of a faucet or fluid outlet, showing the installation of the fluid illumination means of the present invention installed.

FIG. 3B is a cut away view of the illumination means installed in a faucet spout.

FIG. 4A is a side view of a beverage-dispensing tap, showing the installation of the portable alternative embodiment of the present invention.

FIG. 4B is a cut away side view of the portable tap illuminator showing the arrangement of the components within the unit.

Similar reference characters denote corresponding features consistently throughout the several figures of the attached drawings.

### DETAILED DESCRIPTION OF THE PREFERRED EMBODIMENTS

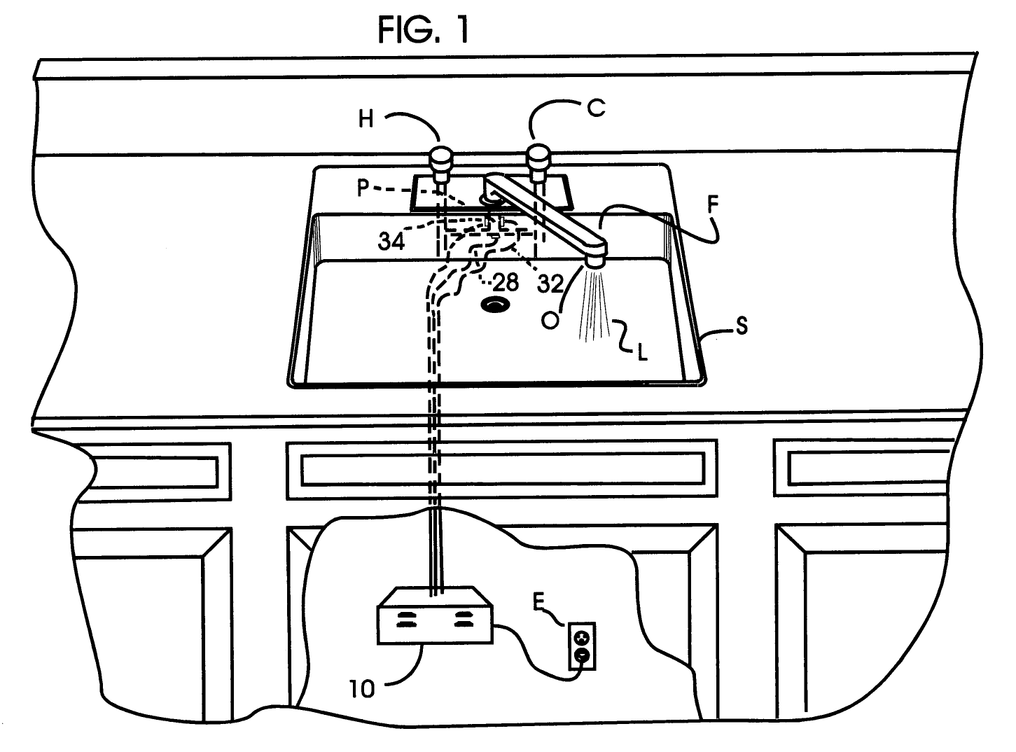

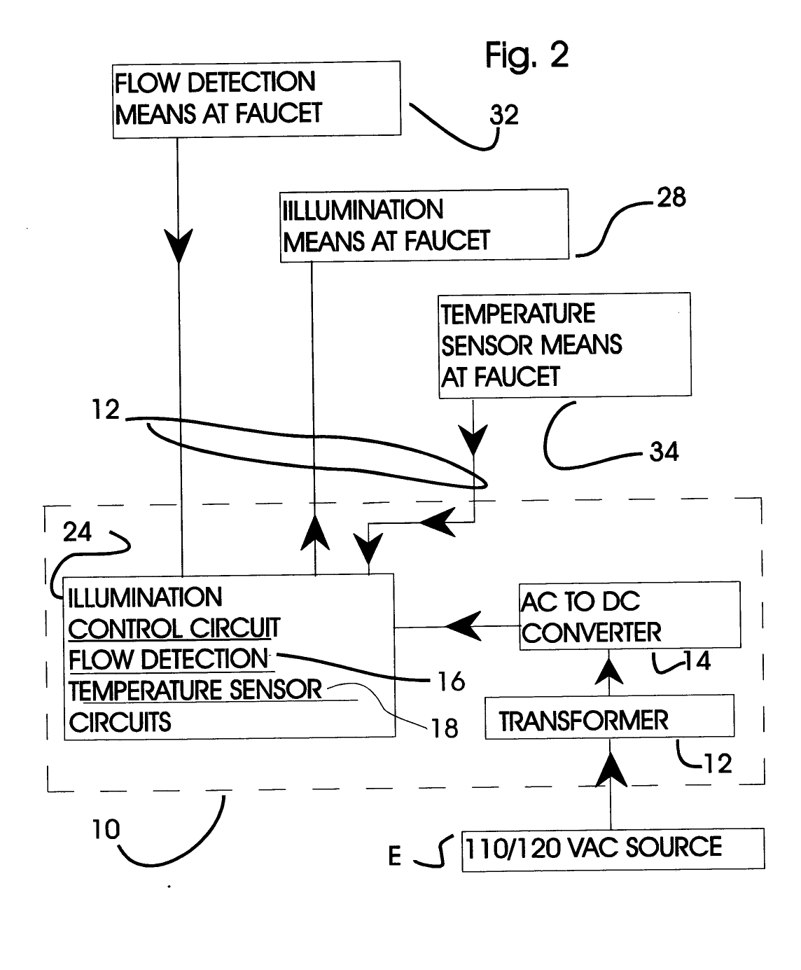

Referring now particularly to FIGS. 1 and 2 of the drawings, the present invention will be seen to relate to a device providing for the automatic illumination of water or other fluid flow from within a faucet, tap or other fluid outlet, and the apparatus comprising the device. The various electrical and electronic components of the fluid illumination device of the present invention are contained in ventilated control box 10, which may be mounted beneath sink S or otherwise located as desired, and within faucet F.

Box 10 may receive electrical power by means of any conveniently located standard 115-volt AC power outlet E, which electrical power is transformed to a lower AC voltage for the operation of the various components of the present invention by means of transformer 12 within the control box 10.

The device of the present invention is actuated when either or both of the hot H or cold C taps or handles are actuated. The flow detection means 32, installed on the bottom surface of faucet F or on pipe P between the hot and cold fluid supply lines, automatically detects the resulting fluid flow through faucet F or pipe P, and provides a signal to the flow detection circuit 16 to turn on the light source 28. The present invention preferably utilizes a non-intrusive means of detecting fluid flow by providing a microphone for the flow detection means 32 on the underside of faucet F or immediately adjacent the pipe P. Any fluid flow through faucet F or pipe P will produce slight vibration, which vibration is detectable in the form of sound by a microphone immediately adjacent faucet to F or the pipe P. Thus, no hole or passage need be formed in the faucet F or side of the pipe P. The activation of the light source 28 causes light to illuminate the stream of liquid or fluid L flowing from the outlet end O of the faucet F, from within the stream.

While this direct illumination of the fluid flow may provide a pleasing effect, the present invention provides further utility by means of the temperature sensor 34 immediately adjacent the faucet F or pipe P. Temperature sensor 34 is installed on the pipe P, or to the under surface of faucet F in the manner of the flow detection means 32, in order to detect accurately and immediately any temperature changes of the fluid within faucet F or pipe P. The material of the faucet F or pipe P will rapidly take on the temperature of the fluid therein, particularly in the case of faucet F or pipe P having high a rate of conductivity, (e.g. copper, iron and most metal pipes). Thus, the thermistor of the temperature sensor means 34 provides practically instantaneous information to the temperature sensing circuit 18 of the present invention.

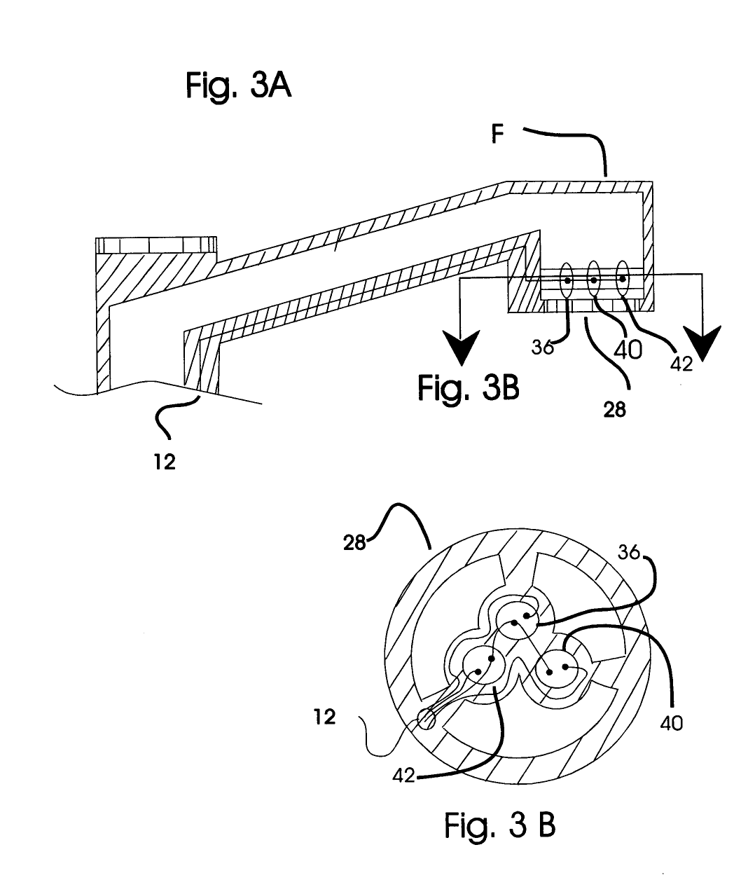

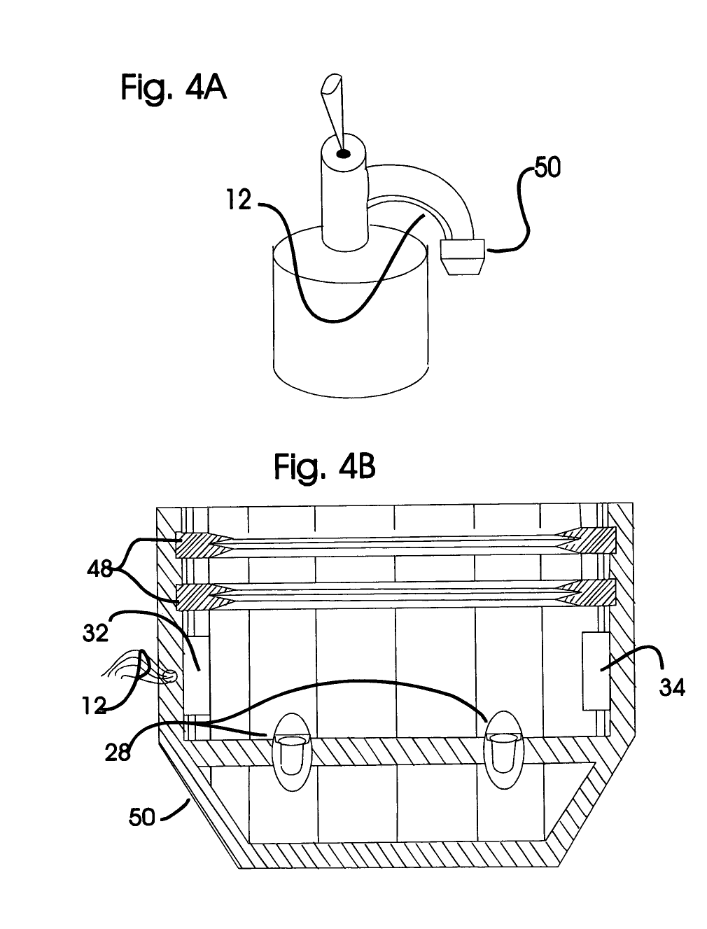

Referring now particularly to FIGS. 4A and 4B note that the temperature indicating illumination preferably includes at least three different colors of indication. The colors are red 36, green 40, and blue 42. It is virtually universal that the color red is equated with heat, the color blue is equated with cold, and green is perceived as a safe to go or operate indication. Accordingly, the present invention is preferably arranged to cause the temperature indicator to illuminate a red color when the temperature sensor means 34 detects a relatively high heat, as shown as 36 in FIGS. 3A and 3B of the drawings.

The resulting red light output will Serve to illuminate the liquid L flowing from faucet outlet O in FIG. 1 with a red tint, thereby providing notice of the high temperature of the liquid L.

If the temperature of the fluid flowing through faucet F or pipe P is lowered (i.e. adjusting the H (hot) or C (cold) handles or depleting the hot water or liquid supply, the temperature sensor means 34 adjacent the faucet F or pipe P will sense the temperature reduction and provide a signal to the illumination control circuit to remove dc power from the red light source 36 and add dc power to the green light source 40 thereby informing the user that the fluid is warm, but not hot. Similar actions serve to color the liquid flow L blue as appropriate to the temperature detected by the temperature sensor means 34, to indicate cold fluid temperature to the user.

Accordingly, the present invention as described above may be used in various environments (e.g. kitchen, bathroom) where hot and cold water or other fluids may flow from a single faucet or outlet. The direct illumination of the fluid flow from within the flow not only provides a pleasing effect, but due to the changing colors provided by the temperature indicator as the fluid temperature changes, the resulting colors can instantly inform a person as to the general temperature of the fluid outflow, without need to look elsewhere to interpret another indicator.

FIGS. 4A and 4B of the drawings disclose a second embodiment of the present invention, that provides for a portable, temporarily installable and removable means of providing direct illumination to a fluid flow from a tap or other fluid outlet. In FIG. 4A a beverage dispenser D having a tap T, for the dispensing of beer, soda, or other beverages, is disclosed. For various reasons (e.g. sanitation and the need for disassembly and cleaning of the apparatus, etc.) it may not be desirable to provide a permanently installed liquid illumination system on dispenser D.

Accordingly, the embodiment of FIG. 4A provides for a portable, temporarily installable and removable illumination system 50 that may be slipped on to the outlet end TO of the tap T. Nozzle 50 is shown in section in FIG. 4B and will be seen to include an axial opening 46 there through, with an upper end 48 that may be or slipped over the outlet end TO of tap T far enough that gaskets 48 form a liquid tight seal between tap T and portable nozzle 50. Flow detection means 32 and temperature sensing means 34 are seen disposed internally on the left and right side of assembly 50 respectively. Multi lead control cable 12 that provides electrical signal connectivity for the temperature sensing means 34, flow detection means 32, and power for illumination means 28, is disposed entering the left wall of the portable assembly.

It will be seen that the beverage or fluid dispensed by a beverage dispenser D will generally be of uniform (generally cold) temperature, however means for indicating the temperature of the beverage is include because occasionally the beverage refrigeration system does fail and early detection of such a problem is paramount.

Moreover the illumination of the beverage flowing from the tap outlet TO can provide a novel and desirable effect, particularly in relatively low light conditions as may be commonly found in bars, taverns and the like. The illuminated beverage flow may serve as a novel means to attract attention to the beverage or other product, and be of some value in advertising, marketing and other purposes. The color(s) available may be limited only by the imagination of the user, and may be readily changed as desired for various occasions, as discussed in the Summary Of The Invention.

Accordingly, the present invention in a first embodiment provides a readily observable and unambiguous indication of a fluid flow and the temperature thereof, directly within the fluid flow.

Alternatively, a second embodiment of the present invention provides a decorative and eye catching means of advertising or marketing and in both embodiments the provision of illumination directly within a fluid outflow, either by means of permanently or temporarily installed apparatus, provides novel advantages for various purposes and in various fields and environments.

It is to be understood that the present invention is not limited to the sole embodiments described above, but encompasses any and all embodiments within them scope of the following claims.

1. A fluid illumination device providing for the illumination of fluid flowing from a fluid conduit having an outlet, with the illumination disposed directly within the flow, said fluid illumination device comprising:
illumination means disposed within the fluid conduit; and a light source providing illumination for said illumination means, whereby;
the flow of fluid from the outlet of said fluid conduit is illuminated from within by said illumination means disposed within the conduit and transmitting the light to the fluid stream;
automatic flow detection means adjacent to said fluid conduit and communicating with said light source, whereby said automatic flow detection means provides automatic actuation of said light source when fluid flow is detected in the conduit;
wherein said automatic detection means includes a microphone or other acoustically sensitive detection device.

2. The fluid illumination device of claim 1 wherein:
said illumination means comprises colored solid-state illumination.

3. The fluid illumination device of claim 1 wherein:
said automatic flow detection means is non-intrusive with respect to said fluid conduit, whereby penetration of the conduit by said automatic flow detection means is precluded.

4. The fluid illumination device of claim 1 including:
means providing for changing and varying the shades of coloring of the fluid illumination wherein:
said means providing for the coloring of the fluid illumination comprises multiple and different colored solid-state illumination devices.

5. The fluid illumination device of claim 2 including:
means providing for the automatically variable coloring of the fluid illumination according to fluid temperature.

6. The fluid illumination device of claim 5 wherein:
said means providing for the automatically variable coloring of the fluid illumination comprises temperature sensor means disposed immediately adjacent the conduit.

7. The fluid illumination device of claim 6 wherein:
said means for automatically varying the color of the fluid illumination comprises a temperature sensing means manufactured within the wall or body of said illumination device.

8. The temperature sensing means of claim 7 wherein:
said temperature sensing means is a solid a state thermistor.

9. The fluid illumination device of claim 6 wherein:
said temperature sensor means is non-intrusive with respect to the conduit, whereby penetration of the conduit by said temperature sensor means is precluded.

10. The fluid illumination device of claim 6 wherein:
said temperature sensor means comprises a thermistor disposed immediately adjacent the fluid conduit, whereby fluid temperature conducted through the conduit is detected by said thermistor.

11. A portable, temporarily installable and removable fluid illumination device providing for the illumination of fluid flowing from a fluid conduit having a flow control handle and an outlet, with the illumination disposed directly within the flow, said portable fluid illumination device comprising: a portable nozzle temporarily installable over the outlet of the conduit, with said portable nozzle including illumination means disposed therein; and whereby;
flow of fluid from the outlet of said fluid conduit is illuminated from within by said illumination means within said portable nozzle, flow detection means and temperature sensing means within said portable nozzle communicate with electronic control circuitry and said light source; wherein
said flow detection means and temperature sensing means are non-intrusive with respect to the conduit, whereby penetration of the conduit by said flow detection means or temperature sensing means is precluded, and said flow detection means provides automatic actuation of said light source when the flow control handle is physically displaced to actuate fluid flow through the conduit and said temperature sensing means automatically controls the color of illumination within the fluid flow.

12. The fluid illumination device of claim 1 whereon:
said microphone includes a sound microphone for detecting sound vibrations emanating from the conduit and caused by fluid flowing through the conduit.
